(19) United States
(12) Patent Application Publication
(10) Pub. No.: US 2006/0146759 A1
(43) Pub. Date: Jul. 6, 2006

(54) MIMO Kalman equalizer for CDMA wireless communication

(76) Inventors: Yuanbin Guo, Irving, TX (US); Jianzhong Zhang, Irving, TX (US); Dennis McCain, Lewisville, TX (US); Joseph R. Cavallaro, Pearland, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/029,900

(22) Filed: Jan. 4, 2005

(51) Int. Cl. H04B 7/216

(52) U.S. Cl. 370/335

(57) ABSTRACT

An apparatus and corresponding method for receiving a MIMO cellular communication signal, the apparatus including: a Kalman filter type of equalizer, responsive to a received signal, for providing a corresponding processed signal indicating information conveyed by the received signal, responsive to a set of values indicating predicted state error correlation at a first instant of time given all noise estimates up through the first instant, for providing ta set of values indicating a product of measurement values and predicted state error correlation at a later instant of time given all process noise estimates up through the later instant. The filter is implemented so as to make use of the displacement structure of the state transition matrix of the Kalman filter allowing shifting operations in place of vector and matrix multiplications. The filter typically includes a transition and common data path that provides to both a Kalman gain processor and a Riccati processor the set of values indicating a product of measurement values and predicted state error correlation at a later instant of time given all process noise estimates up through the later instant.

### BACKGROUND OF THE INVENTION

1. Technical Field

The present invention pertains to the field of wireless communication. More particularly, the present invention pertains to wireless communication using MIMO for communication over a multipath fading communication channel.

2. Discussion of Related Art

MIMO (Multiple-Input-Multiple-Output) spatial multiplexing, i.e. using multiple antennas at both the transmitter and receiver sides of a communication channel, has recently emerged as a significant breakthrough to increase spectral efficiency in communication over wireless communication channels.

On the other hand, to support multimedia services, UMTS (Universal Mobile Telecommunication System) and CDMA2000 (Code Division Multiple Access 2000) extensions optimized for data services have been used as a basis for MC-CDMA (Multi-Code CDMA) systems and the High-Speed Downlink Packet Access (HSDPA) service and its equivalent 1× EV-DV (Evolution Data and Voice)/DO.

MIMO spatial multiplexing according to the prior art works reasonably well for narrow-band and flat-fading communication channels. In a multipath-fading communication channel, however, the orthogonality of the spreading codes used in CDMA-based communication is destroyed and Multiple-Access-Interference (MAI) along with Inter-Symbol-Interference (ISI) is introduced. A conventional rake receiver often does not provide satisfactory performance in case of multi-path fading.

The prior art provides so-called LMMSE (Liner Minimum Mean Squared Error) based algorithms for use in a receiver, and these algorithms have demonstrated fairly good performance in slow-fading channels, but have provided only limited performance in fast-fading channels. Receivers using a Kalman filter (based on a state-space model of the dynamical system) are known to provide substantially better performance for MIMO CDMA downlink in fast-fading environments. However, a Kalman-filter based equalizer component of a receiver has a prohibitively high complexity for real-time hardware implementation in a mobile device. A Kalman filter performs iterations in computing the Kalman gain and providing a next state prediction. The complexity is dominated by numerous multiplications of large matrices and the calculation of an inverse of the innovation correlation matrix in the Kalman gain and next state prediction. For a receiver in a mobile communication device, the hardware for providing the processing power required to provide a real-time Kalman filter functionality is prohibitive.

Thus, what is needed is a receiver suitable for use with MIMO and in case of a multipath fading communication channel, but with relatively low complexity in the sense of processing power needed for real-time operation.

### DISCLOSURE OF INVENTION

Accordingly, in a first aspect of the invention, an apparatus is provided, comprising: a radio section, responsive to a plurality of signals wirelessly received over a communication channel using a plurality of receive antennas, for providing a received signal; and a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

In accord with the first aspect of the invention, the Kalman filter may include a transition and common data path, and the transition and common data path may be responsive to the set of values indicating predicted state error correlation at a first instant of time given all noise estimates up through the first instant, and may provide the set of values indicating a product of measurement values and predicted state error correlation at a later instant of time given all process noise estimates up through the later instant. Further, the Kalman filter may include a gain calculator for providing a Kalman gain, the gain calculator comprising the transition and common data path and further comprising a Riccati processor and a Kalman gain processor, and the set of values indicating a product of measurement values and predicted state error correlation at a later instant of time given all process noise estimates up through the later instant may be provided by the transition and common data path to both the Riccati processor and the Kalman gain processor. Further still, the Kalman filter may also include a state estimator, responsive to the received signal and to the Kalman gain, for providing a filtered state estimate as the processed signal indicating information conveyed by the received signal. Also further still, the transition and common data path may also provide to the Riccati processor a set of values indicating predicted state error correlation at the later instant of time given a set of values indicating predicted state error correlation at the first instant. Still also further still, the Kalman gain processor may be responsive to a set of values indicating measurement noise at the later instant and to the set of values provided by the transition and common data path, and may provide a set of values indicating gain at the later instant.

Also in accord with the first aspect of the invention, transitions from one state to a next state and corresponding error correlations may be determined based on a state transition matrix partitioned into blocks corresponding to a displacement structure, and a shifting operation may be performed instead of a multiplication in determining values corresponding to mathematical expressions including a term in which the state transition matrix multiplies a matrix or a vector. Further, the transitions from one state to a next may be performed based on a state transition equation including the state transition matrix and based on partitioning the state transition equation into blocks with one block for each transmit antenna, and a next state may be determined using the shifting operation for each block. Also further, the filtered state estimates may be determined based on a state estimate equation with terms depending on the state transition matrix and based on partitioning the state estimate equation into blocks with one block for each transmit antenna so as to provide a state estimate equation for each transmit antenna, and a filtered state estimate may be determined using the shifting operation for each block. Still also further, a filter gain may be determined based on innovation equations with terms depending on the state transition matrix and also depending on a measurement matrix representing the communication channel and based on partitioning the measurement matrix into blocks with each block corresponding to a pair of one receive antenna and one transmit antenna, and in some cases, vector multiplication by the measurement matrix may be implemented so as to correspond to a delayed tap line. Still even also further, a conjugate-gradient algorithm and the displacement structure may be used to reduce a matrix inverse operation to one or more matrix-vector or matrix-matrix multiplications.

In a second aspect of the invention, a wireless terminal is provided, including a receiver section having an apparatus, the apparatus comprising: a radio section, responsive to a plurality of signals wirelessly received over a communication channel using a plurality of receive antennas, for providing a received signal; and a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

In accord with the second aspect of the invention, the wireless terminal is either a user equipment device or an entity of a radio access network of a cellular communication system wirelessly coupled to the user equipment device.

In a third aspect of the invention, a system is provided, comprising a user equipment device and an entity of a radio access network of a cellular communication system wirelessly coupled to the user equipment device, wherein at least either the user equipment device or the entity of the radio access network include an apparatus, comprising: a radio section, responsive to a plurality of signals wirelessly received over a communication channel using a plurality of receive antennas, for providing a received signal; and a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

In a fourth aspect of the invention, a method is provided, comprising: wirelessly receiving a plurality of signals over a communication channel using a plurality of receive antennas, for providing a received signal; and Kalman filtering the received signal so as to provide a corresponding processed signal indicating information conveyed by the received signal, based on processing a set of values indicating predicted state error correlation at a first instant of time given all noise estimates up through the first instant so as to provide a set of values indicating a product of measurement values and predicted state error correlation at a later instant of time given all process noise estimates up through the later instant.

In a fifth aspect of the invention, a computer program product is provided, comprising a computer readable storage structure embodying computer program code thereon for execution by a computer processor, wherein said computer program code comprises instructions for performing a method comprising: wirelessly receiving a plurality of signals over a communication channel using a plurality of receive antennas, for providing a received signal; and Kalman filtering the received signal so as to provide a corresponding processed signal indicating information conveyed by the received signal, based on processing a set of values indicating predicted state error correlation at a first instant of time given all noise estimates up through the first instant so as to provide a set of values indicating a product of measurement values and predicted state error correlation at a later instant of time given all process noise estimates up through the later instant.

### BRIEF DESCRIPTION OF THE DRAWINGS

The above and other objects, features and advantages of the invention will become apparent from a consideration of the subsequent detailed description presented in connection with accompanying drawings, in which:

FIG. 1 A is a block diagram/flow diagram of a filter according to the invention, showing a common data path.

FIG. 1B is a block diagram/flow diagram of a receiver component for receiving MIMO signals, having a radio receiver section and a Kalman filter section according to the invention and as shown in more detail in FIG. 1A.

FIG. 1C is a block diagram showing the receiver component of FIG. 1B in both a wireless terminal serving as a UE device, and in a wireless terminal serving as a Node B (or sometimes called a base station transceiver) of a radio access network of a cellular communication system.

FIG. 2 is a schematic illustrating how a next state estimate is determined (i.e. how a state estimate is projected forward in time) without matrix multiplication, according to the invention.

FIG. 3 is a schematic illustrating how a next error correlation matrix estimate is determined (i.e. how an error correlation matrix estimate is projected forward in time) without matrix multiplication, according to the invention.

FIG. 4 is a functional logic block diagram of a module for providing an FFT-based observation estimate.

FIG. 5A is a schematic illustration of the effective data in Ω^{H}(k).

FIG. 5B is a schematic illustration of the effective data in Π(k).

### BEST MODE FOR CARRYING OUT THE INVENTION

The invention provides an efficient VLSI (Very Large Scale Integration) oriented recursive architecture for a MIMO Kalman equalizer in a receiver for CDMA-based communications. As described below, many redundant matrix-matrix multiplications are eliminated in the block-displacement structure (by using a simple data loading process), substantially lowering the complexity and therefore the processing power requirements of the hardware used by the receiver. A divide-and-conquer methodology is applied to partition the MIMO displacement structure into more tractable sub block architectures in the Kalman recursion. By utilizing the block Toeplitz structure of the channel matrix, an FFT-based acceleration is proposed to avoid direct matrix-matrix multiplications in the time domain for predicted state-error correlation matrix and Kalman gain. Finally, an iterative Conjugate-Gradient (CG) based algorithm is proposed to avoid the inverse of the Hermitian innovation correlation matrix in the Kalman gain computer. Further, the data path in the receiver is streamlined by combining the displacement and block-Toeplitz structure. The proposed architecture not only reduces the numerical complexity to O(N·log N) (i.e. order of N·log N) per chip, but also facilitates parallel and pipelined real-time VLSI implementations. The potential performance gain can be more than 2 dB, compared with existing FIR (Finite Impulse Response) LMMSE solutions. Possible applications of the invention include downlink CDMA mobile devices that comply with either CDMA2000 or a WCDMA standard.

The performance of a receiver according to the invention is better than a receiver using a FIR LMMSE chip equalizer, and its tracking capability is also superior. Its computational complexity is reduced significantly from that of a receiver using a conventional Kalman filter because of using the above-mentioned displacement structure, a FFT acceleration, and an iterative inverse solver, all described in more detail below.

1. Review and Notation

By way of background, a so-called Toeplitz matrix is any n x n matrix with values constant along each (top-left to lower-right) diagonal. That is, a Toeplitz matrix has the form

$$[ \begin{matrix}{α}_{0} & {α}_{1} & {α}_{2} & ⋯ & {α}_{n - 1} \\ {α}_{- 1} & {α}_{0} & {α}_{1} & ⋰ & ⋮ \\ {α}_{- 2} & {α}_{- 1} & {α}_{0} & ⋰ & {α}_{2} \\ ⋮ & ⋰ & ⋰ & ⋰ & {α}_{1} \\ {α}_{- ( n - 1 )} & ⋯ & {α}_{- 2} & {α}_{- 1} & {α}_{0}\end{matrix} ]$$

Numerical problems involving Toeplitz matrices typically have fast solutions. For example, the inverse of a symmetric, positive-definite n×n Toeplitz matrix can be found in O(n²) time.

Regarding using so-called displacement structure in calculations involving matrices, a displacement operator V is sometimes defined as mapping an m×n matrix V into a new m×n matrix as follows: ∇(V)=DV−VA, where D is some m×m and A is some n×n matrix. The ∇-displacement rank of V is defined as the rank of the matrix ∇(V). If this rank is a, then ∇(V) can be written as GB with G an m×a matrix and B an a×n matrix. The pair (G, B) is then called a ∇-generator for V. If α is small and D and A are sufficiently simple, then the ∇-operator allows compressing the matrix V to matrices with a total of (m+n) entries. It turns out that one can efficiently compute matrix expressions with the compressed form.

First, we introduce the notation used in the description here, and also review the basics of the procedure used in processing by a Kalman filter. We consider the system model of the MIMO CDMA downlink based on spatial multiplexing with M Tx antennas and Nᵣ Rx antennas. First, the high data rate symbols are demultiplexed into U*M lower-rate substreams, where U is the number of spreading codes used in the system for data transmission. The substreams are broken into M groups, where each substream in the group is spread with a spreading code of spreading factor F. The groups of substreams are then combined and scrambled with long scrambling codes and transmitted through the t^{th} Tx antenna. The chip level signal at the t^{th} transmit antenna is given by,
xₜ(i)=Σᵤ₌₁^{U}sₜ^{u}(j)·cₜ^{u}[i]+sₜ^{P}(j)·cₜ^{P}[i] (1)
where j is the symbol index, i is chip index and u is the index of the composite spreading code. sₜ^{u}[j] is the j^{th} symbol of the u^{th} code at the t^{th} substream. In the following, we focus on the j^{th} symbol index and omit the index for simplicity. cₜ^{u}[i]=c^{u}[i]cₜ^{(s)}[i] is the composite spreading code sequence for the u^{th} code at the t^{th} substream where c^{u}[i] is the user specific Hadamard spreading code and cₜ^{(s)}[i] is the antenna specific scrambling long code. sₜ^{P}[i] denotes the pilot symbols at the th antenna. cₜ^{P}[i]=c^{P}[i]cₜ^{(s)}[i] is the composite spreading code for pilot symbols at the to antenna. The received chip level signal at the r^{th} Rx antenna is given by

$${y}_{r} ( i ) = {\sum }_{t = 1}^{M} {\sum }_{l = 0}^{{L}_{t , r}} {h}_{t , r} ( l ) {x}_{t} ( i - {τ}_{l} ) + {v}_{t} ( i ) . \qquad ( 2 )$$

The channel is characterized by a channel matrix between the t^{th} Tx antenna and the r^{th} Rx antenna as

$${h}_{t , r} ( t ) = {\sum }_{l = 0}^{{L}_{t , r}} {h}_{t , r} ( l ) δ ( t - {τ}_{t , r , l} ) . \qquad ( 3 )$$

By collecting the F consecutive chips at the k^{th} symbol from each of the Nᵣ Rx antennas in a signal vector yᵣ(k)=yᵣ(kF+F−1), . . . , yᵣ(kF)]^{T} and packing the signal vectors from each receive antenna, we form a signal vector as y(k)=[y₁(k)^{T}, . . . ,yᵣ(k)^{T}, . . . ,y_{N}(k)^{T}]^{T}. Here F is the spreading gain. In vector form, the received signal can be given by

$${y}_{r} ( k ) = {\sum }_{t = 1}^{M} {H}_{t , r} ( k ) {x}_{t} ( k ) + {v}_{r} ( k ) = {H}_{r} ( k ) x ( k ) + {v}_{r} ( k ) \qquad ( 4 )$$

where vᵣ(k) is the additive Gaussian noise. The transmitted chip vector for the t^{th} transmit antenna is given by xₜ(k)=[x₁(kF+k−1) . . . xₜ(kF) . . . xₜ(kF−D)]^{T} and the overall transmitted signal vector is given by stacking the substreams for multiple transmit antennas as x(k)=[x₁(k)^{T} . . . xₜ(k)^{T} . . . x_{M}(k)^{T}]^{T}. D is the channel delay spread. The channel matrix from multiple transmit is defined as Hᵣ(k)=[H_{l,r}(k) . . . H_{t,r}(k) . . . H_{M,r}(k)], where H_{t,r}(k) is the channel matrix from the t^{th} transmit antenna and r^{th} receive antenna.

The Kalman filter theory provides a recursive computation structure and best linear unbiased estimate (BLUE) of the state of a linear, discrete time dynamical system. However, the application of the theory in a particular field depends on the choice of the state-space model, which is not specified in the fundamental theory. Here, we follow a model that associates the Kalman theory with the MIMO CDMA downlink equalization.

The Kalman filter estimates the state x given the entire observed data y(1), . . . ,y(k). The Kalman filter is derived from a state-space model consisting of a measurement equation and a process equation. The measure equation describes the generation model of the observation y from the state x in a stochastic noise process. The process equation describe the state transition of the new estimate x(k) at time k from the estimate x(k−1) at time k-l. It is assumed that the transition matrix satisfies the product rule and the inverse rule.

By defining the transition matrix as Θ(k), it is natural to have the measurement equation as the received signal model and the process equation as an excitation of some process noise,
y(k)=H(k)x(k)+v(k) (5)
x(k)=Θ(k)x(k−1)+w(k) (6)
where the measure matrix is the overall MIMO channel matrix H(k) given by H(k)=[Hₗ(k)^{T} . . . Hᵣ(k)^{T} . . . H_{Nr}(k)^{T}]. v(k) denotes the measurement noise and w(k) denotes the process noise.
2. Kalman Filter According to the Invention
a. Common Data Path

Based on an examination of the timing dependency and the physical meaning of the Kalman procedure, the invention provides a reduced or streamlined Kalman filter, so-called because a Kalman filter according to the invention includes a data path common to different components of the filter.

The Kalman filter solves the process and the measurement equations jointly for the unknown states in an optimal manner. An innovation process and the correlation matrix of the innovation process are defined by
a(k)=y(k)−ŷ(k|k−1) (7)
R(k)=E[α(k)α^{H}(k)] (8)
whose physical meaning represents the new information in the observation data y(k). ŷ(k|k−1) denotes the MMSE of the observed data y(k) at time k, given all the past observed data from time 1 to k-1. It is shown that
R(k)=H(k)P(k|k−1)H^{H}(k)+Qᵥ(k) (9)
where the P(k|k−1) matrix is the predicted state error correlation matrix defined by
P(k|k−1)=E[ε(k|k−1)ε^{H}(k|k−1) (10)
Here ε(k|k−1)=\hat{x}(k)−\hat{x}(k|k−1) is the predicted state error vector at time k, using data up to time k−1. By defining a Kalman gain as G(k)=E[x(k)α^{H}(k)]R⁻¹(k), the new state estimate can be given by
\hat{x}(k|k)=Θ(k)x(k|k−1)+G(k)α(k). (11)

The physical meaning is that we may compute the MMSE \hat{x}(k|k) of the state of a linear dynamical system by adding a correction item G(k)α(k) to the previous estimate, which is pre-multiplied by the transition matrix Θ(k). The Riccati equation provides a recursive computation procedure of the predicted state error correlation matrix P(k|k−1) and the Kalman gain. By analyzing the data dependency and the timing relationship, the streamlined procedure is given in Table I.

TABLE I
Summary of the commonality extracted Kalman procedure

Init:

\hat{x}(0 | 0) = E[x(0)]
P(0 | 0) = E{[x(0) − \hat{x}(0 | 0)][x(0) − \hat{x}(0 | 0)]^{H}}

Input vector: y(k); Output vector: \hat{x}(k | k)
Predefined parameters:
Transition matrix = Θ(k); Measure matrix = H(k);
Correlation matrix of the process noise: Q_{w}(k) = E[w(k)w^{H}(k)]
Correlation matrix of the measure noise: Qᵥ(k) = E[v(k)v^{H}(k)].
Recursion for k = 1, 2, . . .
(1). State transition equations

\hat{x}(k | k − 1) = Θ(k)\hat{x}(k − 1 | k − 1)
P(k | k − 1) = Θ(k)P(k − 1 | k − 1)Θ(k)^{H} + Q_{w}(k)

(2). Innovation generation

α(k) = y(k) − H(k)\hat{x}(k | k − 1)
Ω(k) = H(k)P(k | k − 1)

(3). Kalman gain computation

R(k) = H(k)Ω^{H} (k) + Qᵥ(k)
G(k) = Ω^{H} (k)R⁻¹(k)

(4). State estimate & Predicted−state error correlation update

\hat{x}(k | k) = \hat{x}(k | k − 1) + G(k)α(k)
P(k | k) = P(k | k − 1) − G(k)Ω(k)

One thing to note here is that, in most Kalman filter notations, the innovation correlation matrix is generated by first pre-multiplying the measurement matrix and then post-multiplying the Hermitian transpose of the measurement matrix as R(k)=H(k)P(k|k−1)H^{H}(k)+Qᵥ(k). However, it is easy to shown that P(k|k−1) is Hermitian symmetric, thus we introduce an intermediate matrix Ω(k)=H(k)P(k|k−1) by only pre-multiplying the channel matrix to it. The generation of the R(k) is formed in a generic R(k)=H(k)Ω^{H}(k)+Qᵥ(k). This change of form will facilitate the complexity reduction as will be shown later.

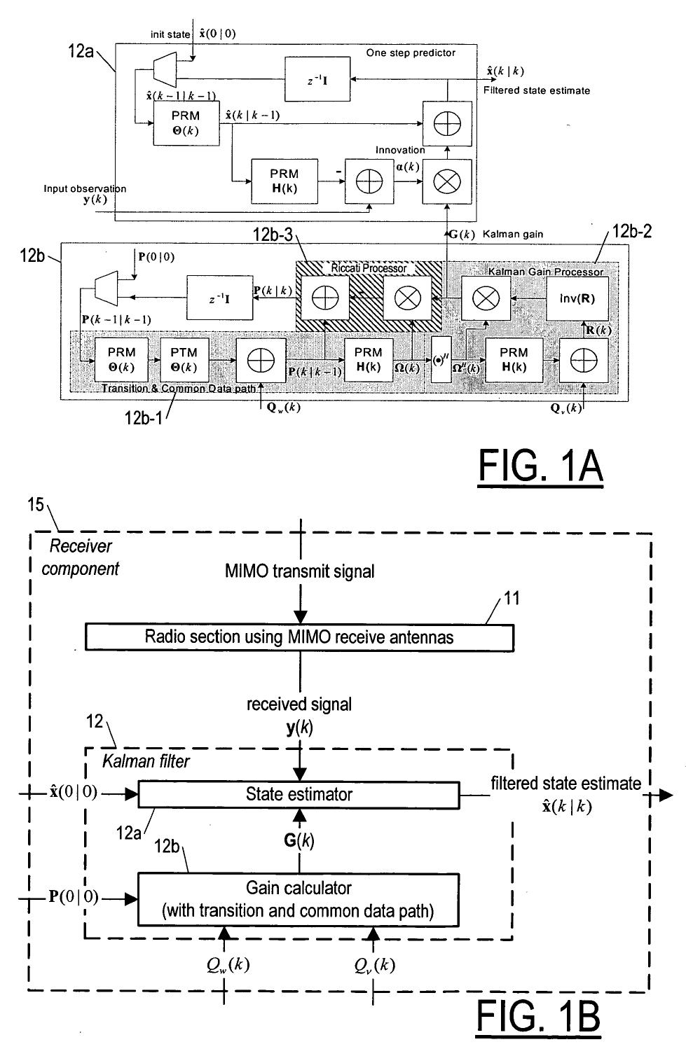

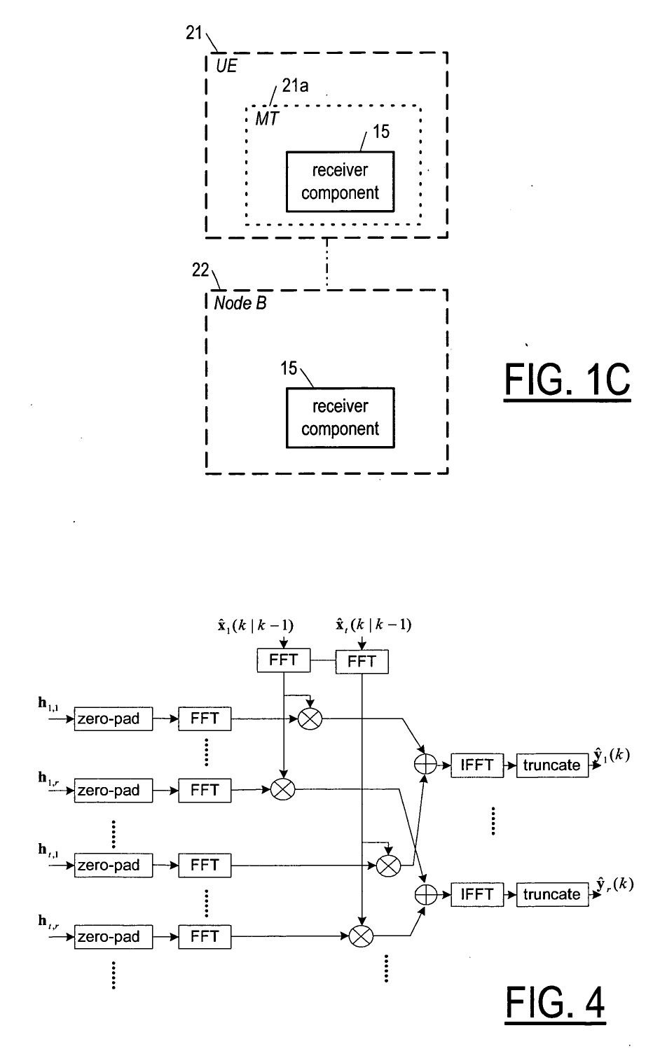

Referring now to both FIG. 1A and FIG. 1B, a receiver component 15 for receiving a MIMO wireless signal according to the invention includes a radio section 11 including more than one receive antenna, for providing a received signal/input observation y(k), which is input to a Kalman filter 12 including a state estimator 12a and gain calculator 12b, where the latter, so as to facilitate VLSI, includes a transition and common data path 12b-1, which performs processing providing outputs to both a (Kalman) gain processor 12b-2 and a Ricatti processor 12b-3.

The filter 12 provided by the invention can be implemented in various ways, as is known in the art. For example, the filter can be provided as a special purpose integrated circuits—i.e. an application specific integrated circuit (ASIC)—or a combination of ASICs, or can be implemented as software in a more general purpose integrated circuit (e.g. a general purpose microprocessor or ). The filter 12 and radio section 11 can be components of a user equipment device (such as a mobile phone or any other kind of wireless terminal equipped for cellular communication), or can be components of a service access point (SAP) of a radio access network (RAN) of a cellular communication network. The invention is best implemented in the same manner as for most other equalization algorithms for wireless receivers. Typically, the invention would be implemented as software to be embedded in a general-purpose signal processing chip. The faster alternative of course is to implement the invention in an ASIC. Like any filter using a non-blind equalization method, a filter according to the invention requires that an estimate of the channel parameters be available and thus is only part of a comprehensive receiver, which includes a channel estimator.

Referring now to FIG. 1C and also to FIG. 1B, the receiver component 15 can be used in a wireless terminal serving as a UE (user equipment) device 21, as part of the MT (mobile terminal) component 21 a of the UE device, and/or as a component of a Node B 22 (sometimes called a base station transceiver).

FIGS. 1A-1C indicate both equipment modules (logical or actual) and steps of a method performed by equipment. Thus, for example, corresponding to the gain calculator module 12b, there is a gain calculator step that provides the Kalman gain for use by the state estimator module 12a (or corresponding state estimator step).

The logic block diagram of the VLSI oriented architecture according to the invention is shown in FIG. 1A. The architecture is constructed with two parallel feedback loop structures that are associated with a common Kalman gain G(k). On the top is the one step predictor of the state \hat{x}(k|k) using the input observation y(k). A MUX first selects either the init state \hat{x}(0|0) or the delayed feedback state estimate for \hat{x}(k−1|k−1), where z⁻¹I in the figure denotes the sample delay operator used in defining the z-transform of a sequence vector or matrix. The \hat{x}(k−1|k−1) is first pre-multiplied (PRM) by the transition matrix to generate \hat{x}(k|k−1) and then pre-multiplied by the channel matrix H(k). The result is subtracted from the input observation y(k) to generate the innovation process α(k). The innovation is then multiplied by the Kalman gain G(k) and added to the \hat{x}(k|k−1) to finally generate the filtered state estimate \hat{x}(k|k). The dynamical transition is repeated for each time k to get state sequence estimate.

On the bottom is the feedback loop of the predicted state error correlation P(k|k) and the Kalman gain computer. Similarly, a MUX first selects from the init value P(0|0) or the delayed feed P(k|k) for the P(k−1|k−1). It is pre-multiplied and then post-multiplied by the transition matrix. The correlation of the process noise Q_{w}(k) is then added to form an intermediate correlation P(k|k−1). This is pre-multiplied by H(k) to generate the Ω(k), whose result is then Hermitian transposed. Note that the Hermitian transpose is a virtual operation with no time/memory resource usage because the subsequential operations can use the structure of Ω^{H}(k) explicitly. Ω^{H}(k) is pre-multiplied by H(k) and the result is added to the measurement noise correlation matrix Qᵥ(k) to form the innovation correlation R(k). The Kalman is produced as the result of the pre-multiplication of Ω^{H}(k) with the inverse of R(k). The P(k|k) is then updated in the Riccati processor accordingly. In this streamlined data path, the commonality for the Riccati processor and Kalman gain processor is extracted as the dotted gray area. The timing and dependency relationship between each block is indicated. The recursive structure is reduced to several pre/post-multiplications by the transition matrix, the pre-multiplications by the channel matrix and one inverse.

b. MIMO Displacement Structure

Despite streamlining to reduce redundancy, the computation complexity still remains the same order. Both the matrix inverse and the matrix-matrix multiplication have O(N³) complexity for an N×N matrix. It turns out that because the transition matrix has some displacement structure, the matrix multiplication complexity can be dramatically reduced.

It has been shown that the transition matrix can be expressed as follows, indicating a block displacement structure:

$$Θ ( k ) = {I}_{M} ⊗ \tilde{Θ} ( k ) , where \\ \tilde{Θ} ( k ) = [ \begin{matrix}{0}_{F \times D} & {0}_{F \times F} \\ {I}_{D \times D} & {0}_{D \times F}\end{matrix} ] \qquad ( 12 )$$

where F is the spreading factor in the spreading codes, D is the channel delay spread, I_{M} is an identity matrix of size M×M with only diagonal elements 1, \textcircled{·} is the Kronecker product, and M is the number of transmit antennas (and note that M has no relationship to F and D). Using the Kronecker product, the matrix in (12) can be expanded as follows:

$$Θ ( k ) = {I}_{M} ⊗ \tilde{Θ} ( k ) = [ \begin{matrix}[ \begin{matrix}{0}_{F \times F} & {0}_{F \times F} \\ {I}_{D \times D} & {0}_{D \times F}\end{matrix} ] & & 0 \\ & ⋰ & \\ 0 & & [ \begin{matrix}{0}_{F \times D} & {0}_{F \times F} \\ {I}_{D \times D} & {0}_{D \times F}\end{matrix} ]\end{matrix} ] , where$$

$${I}_{M} = {[ \begin{matrix}1 & & 0 \\ & ⋰ & \\ 0 & & 1\end{matrix} ]}_{M \times M} .$$

The process noise is then given by w(k)=[w₁(k)^{T} . . . wₜ(k)^{T} . . . w_{M}(k)^{T}]^{T} where the process noise for the t^{th} transmit antenna is given by wₜ(k)=[xₜ(kF+k−1) . . . xₜ(kF)0 . . . 0]^{T}. It is easy to verify that to pre-multiply a matrix with \tilde{Θ}(k) is equivalent to shifting the first D rows of the matrix to the bottom and adding F rows of zeros to the upper portion. To post-multiply a matrix with \tilde{Θ}(k) is equivalent to shifting the first D columns of the matrix to the right and adding F rows of zeros to the left portion. For the MIMO case, the feature forms a block-displacement structure and will be applied to related computations.
b-1. State Transition Equation

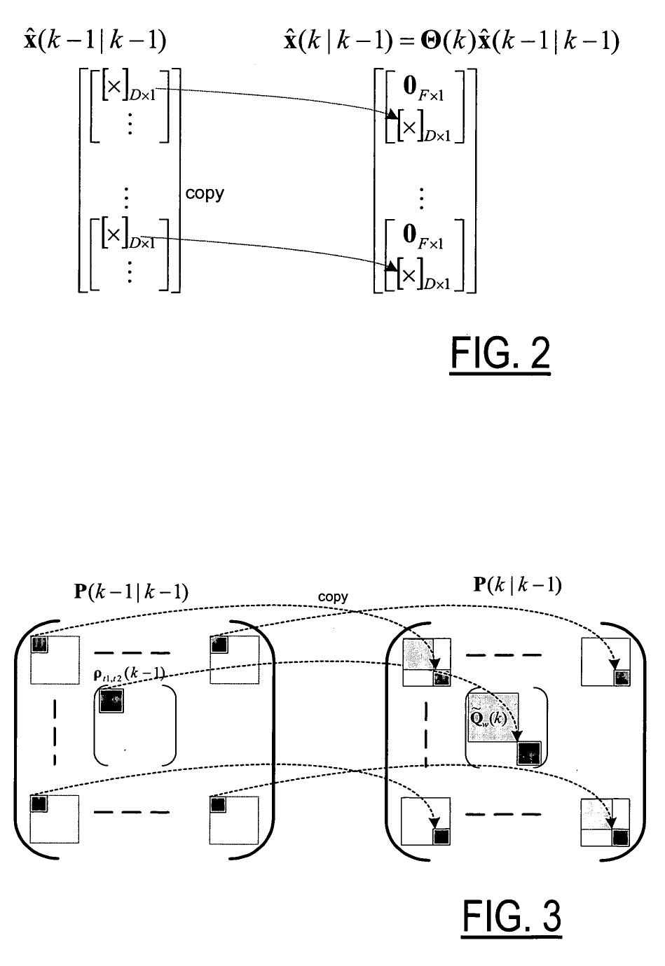

It is shown that the state transition equation can be partitioned into M transmit antennas using the Kronecker product \hat{x}(k|k−1)=[\hat{x}₁(k|k−1)^{T} . . . \hat{x}ₜ(k|k−1)^{T} . . . \hat{x}_{M}(k|k−1)^{T}]^{T}. Thus, the t^{th} sub block of the transition is given by
\hat{x}ₜ(k|k−1)=\tilde{Θ}(k)\hat{x}ₜ(k−1|k−1)=[0_{1×F} \hat{x}ₜ^{U}(k−1|k−1)^{T}]^{T}
where
\hat{x}ₜ^{U}(k−1|k−1)≡[\hat{x}ₜ(k−1|k−1,0) . . . \hat{x}ₜ(k−1|k−1,D−1)]^{T}
is the upper D rows of the previous state. This partitioning process is shown in FIG. 2.
b-2. Filtered State Estimation Output & Feedback

This displacement structure can be further applied in the filtered state estimation and feedback process. Similarly we can partition the update equation
\hat{x}(k|k)=\hat{x}(k|k−1)+G(k)α(k)
into
\hat{x}ₜ(k|k)=\hat{x}ₜ(k|k−2)+Gₜ(k)α(k)
where \hat{x}(k|k)=[\hat{x}ₜ^{U}(k|k)^{T} . . . ]^{T}, and G(k)=[. . . Gₜ^{T} . . . ]^{T}. We further partition the element-wise state estimate and the Kalman gain into three sub-blocks, the upper D rows, the lower D rows and the rest rows in the center as
\hat{x}ₜ(k|k)=[\hat{x}ₜ^{U}(k|k)^{T}\hat{x}ₜ^{C}(k|k)^{T}\hat{x}ₜ^{L}(k|k)^{T}]^{T} and Gₜ(k)^{T}=[Gₜ^{U}(k)^{T}Gₜ^{C}(k)^{T}Gₜ^{L}(k)^{T}]^{T}.
We define the effective transition state vector Xₜ^{L}(k−1) as the lower D rows of the state at time (k−1). It can be shown from the transition that the upper and center portions of the new states do not need to add the previous states. Only the lower portion is updated from the previous state with the Kalman gain. Then the new effective transition state vector is simply a copy of the new upper portion of the state. In the real-time implementation, only this portion is stored and fed back to form the state transition, according to the following.
\hat{x}ₜ^{U}(k|k)=Gₜ^{U}(k)α(k) \hat{x}ₜ^{C}(k|k)=Gₜ^{C}(k)α(k) \hat{x}ₜ^{L}(k|k)=xₜ^{L}(k−1)+Gₜ^{L}(k)α(k) xₜ^{L}(k)=\hat{x}ₜ^{U}(k|k) (13)
This can accelerate the feedback before the whole vector is ready. The transition matrix-vector multiplication and part of the vector addition are eliminated. The storage of the transition vector is also reduced.
b-3. Predicted State Error Correlation Matrix

Another process involved with the transition matrix is the computation of the predicted state error correlation matrix P(k|k−1)=Θ(k)P(k−1|k−1)Θ(k)^{H}+Q_{w}(k). It is shown that the process noise correlation is given by

$${Q}_{w} ( k ) = E \{ w ( k ) {w ( k )}^{H} \} = {I}_{M} ⊗ Q ( k ) , where \\ Q ( k ) = [ \begin{matrix}{\tilde{Q}}_{w} ( k ) & {0}_{F \times D} \\ {0}_{D \times F} & {0}_{D \times D}\end{matrix} ] . \qquad ( 14 )$$

Thus if we span the MIMO correlation matrix from the sub blocks as P(k|k−1)=span {P_{t1,t2}(k|k-1)} and P(k-1|k-1)=span{P_{t1,t2}(k−1|k−1)} for t₁ and t₂=1 to M, we can get the partition sub blocks given by
Pₜ_{₁}_{,t}_{₂}(k|k−1)=\tilde{Θ}(k)Pₜ_{₁}_{,t}_{₂}(k−1|k−1)\tilde{Θ}(k)^{H}+Qₜ_{₁}_{,t}_{₂}(k), where Qₜ_{₁}_{,t}_{₂}(k)=Q(k)δ(t₁−t₂). (15)
By span {P_{t1,t2}(k|k−1)}, we mean that the matrix P(k|k−1) is formed by the submatrices P_{t1,t2}(k|k−1) where t1 and t2 are the subblock indices, i.e.,

$$P ( k \vert k - 1 ) = [ \begin{matrix}{P}_{11} ( k \vert k - 1 ) & ⋯ & {P}_{M 1} ( k \vert k - 1 ) \\ ⋮ & {P}_{t 1 , t 2} ( k \vert k - 1 ) & \\ {P}_{1 M} ( k \vert k - 1 ) & & {P}_{MM} ( k \vert k - 1 )\end{matrix} ] .$$

With the feature of the pre-multiplication and post-multiplication with the displacement transition matrix, we can show that the new state error correlation matrix is given by the following partitioning,

$$\{ \begin{matrix}{P}_{t 1 , t 2} ( k \vert k - 1 , F : F + D - 1 , F : F + D - 1 ) = {ρ}_{t 1 , t 2} ( k - 1 ) \\ {P}_{t , t} ( k \vert k - 1 , 0 : F - 1 , 0 : F - 1 ) = {\tilde{Q}}_{w} ( k ) \\ {P}_{t 1 , t 2} ( k \vert k - 1 , i , j ) = 0 , o . w .\end{matrix} \qquad ( 16 )$$

where the sub block matrix ρₜ_{₁}ₜ_{₂}(k−1) is a D×D left-upper corner of the partitioned correlation matrix defined by
ρₜ_{₁}ₜ_{₂}(k−1)=Pₜ_{₁}_{,t}_{₂}(k−1|k−1,0:D−1,0:D−1). (17)
Thus, the matrix multiplications and additions in computing P(k|k−1) from P(k−1|k−1) are all eliminated. Logically we only need to copy some small sub-blocks of P(k−1|k−1) to Q_{w}(k) following the special pattern. Actually, the storage of the full matrix is not necessary since the matrix is sparse with many zero entries. This displacement procedure is demonstrated by the data loading process in FIG. 3.
b-4. Update State Error Correlation Matrix

Jointly considering the feedback data path of P(k|k) and the displacement structure in P(k|k−1), it is clear that only the upper left corner ρₜ_{₁}_{,t}_{₂}(k−1) are utilized for the element matrix P_{t1,t2}(k−1|k−1). The other elements are redundent information that will be dropped during the displacement procedure. Thus, there is no need to compute and keep these components. Because there is matrix multiplication of the Kalman gain with Ω(k) as in P(k|k)=P(k|k−1)−G(k)Ω(k), we define an intermediate variable Ψ(k) for the multiplication and partition it to MIMO sub-blocks as

$$Ψ ( k ) = G ( k ) Ω ( k ) = [ \begin{matrix}{Ψ}_{11} ( k ) & ⋯ & {Ψ}_{1 M} ( k ) \\ ⋮ & & \\ {Ψ}_{M 1} ( k ) & & {Ψ}_{MM} ( k )\end{matrix} ] . \qquad ( 18 )$$

Instead of computing the full matrix of P(k|k), we only need to compute the relevant submatrices given by
ρₜ_{₁}_{,t}_{₂}(k)=Pₜ_{₁}_{,t}_{₂}(k|k−1,0:D−1,0:D−1)+Ψₜ_{₁}_{,t}_{₂}(k,0:D−1,0:D−1) (19)
We also partition the Kalman Gain G(k) and the Ω(k) matrices into MIMO sub blocks as

$$G ( k ) = [ \begin{matrix}{G}_{1 , 1} ( k ) & … & {G}_{1 , Nr} ( k ) \\ ⋮ & {G}_{t , r} ( k ) & \\ {G}_{M , 1} ( k ) & & {G}_{M , Nr} ( k )\end{matrix} ] , \\ Ω ( k ) = [ \begin{matrix}{Ω}_{1 , 1} ( k ) & … & {Ω}_{1 , M} ( k ) \\ ⋮ & {Ω}_{r , t} ( k ) & \\ {Ω}_{Nr , 1} ( k ) & & {Ω}_{Nr , M} ( k )\end{matrix} ] \qquad ( 20 )$$

where Gₜ_{₁}_{,t}_{₂}(k)=[G_{t,r}^{U}(k)^{T} G_{t,r}^{L}(k)^{T} is further partitioned into the upper and lower sub-matrices while Ω_{r,t}(k)=[Ω_{r,t}^{L}(k) Ω_{r,t}^{R}(k)] into the left and right sub-matrices of the following sizes as
G_{t,r}^{U}(k): upper D×F Ω_{r,t}^{L}(k): left, F×D
G_{t,r}^{L}(k): lower F×F+ Ω_{r,t}^{R}(k): right, F×F
It is clear that the element block in the Ψ(k) is given by

$$\begin{matrix}{Ψ}_{{t}_{1} , {t}_{2}} ( k ) = {\sum }_{r = 1}^{Nr} {G}_{{t}_{1} , r} ( k ) {Ω}_{r , {t}_{2}} ( k ) \\ = [ \begin{matrix}{\sum }_{r = 1}^{Nr} {G}_{{t}_{1} , r}^{U} ( k ) {Ω}_{r , {t}_{2}}^{L} ( k ) & {\sum }_{r = 1}^{Nr} {G}_{{t}_{1} , r}^{U} ( k ) {Ω}_{r , {t}_{2}}^{R} ( k ) \\ {\sum }_{r = 1}^{Nr} {G}_{{t}_{1} , r}^{L} ( k ) {Ω}_{r , {t}_{2}}^{L} ( k ) & {\sum }_{r = 1}^{Nr} {G}_{{t}_{1} , r}^{L} ( k ) {Ω}_{r , {t}_{2}}^{R} ( k )\end{matrix} ] .\end{matrix} \qquad ( 21 )$$

Comparing the displacement structure, only the left-upper corner of size D×D is necessary, which is given by

$$\begin{matrix}{Ψ}_{{t}_{1} , {t}_{2}} ( k ) = {Ψ}_{{t}_{1} , {t}_{2}} ( k , 0 \text{:} D - 1 , 0 \text{:} D - 1 ) \\ = {\sum }_{r = 1}^{Nr} {G}_{{t}_{1} , r}^{U} ( k ) {Ω}_{r , {t}_{2}}^{L} ( k ) .\end{matrix}$$

This is only associated with the upper part of G_{t1,r}(k) and left part of Ω_{r,t2} (k). As a summary, the updated effective state error correlation is simplified by adding the correction item to the D×D corner of \tilde{Q}_{w}(k) which is constant to the transmit antenna elements t₁ and t₂, according to:
ρₜ_{₁}_{,t}_{₂}(k)=\tilde{Q}_{w}(k,0:D−1,0:D−1)δ(t₁−t₂)+ψₜ_{₁}_{,t}_{₂}(k) (22)
This optimization not only saves many computations and memory storage but also fastens the update and feedback time.
C. FFT Acceleration

The invention also provides an FFT-based architecture. In the innovation and the omega matrix Ω(k) generation, there are some pre-multiplications by the channel matrix H(k) as in α(k)=y(k)−H(k)\hat{x}(k|k−1) and Ω(k)=H(k)P(k|k−1). It can be shown that the matrix has the form:

$$H ( k ) = [ \begin{matrix}{H}_{1 , 1} ( k ) & … & {H}_{M , 1} ( k ) \\ ⋮ & & \\ {H}_{1 , Nr} ( k ) & & {H}_{M , Nr} ( k )\end{matrix} ] .$$

We define the estimated observation and partition it into the sub-vectors for the multiple receive antennas as

$$\begin{matrix}\hat{y} ( k ) = H ( k ) \hat{x} ( k \vert k - 1 ) \\ = [ \begin{matrix}{\sum }_{t = 1}^{M} {H}_{t , 1} ( k ) {\hat{x}}_{t} ( k \vert k - 1 ) \\ ⋮ \\ {\sum }_{t = 1}^{M} {H}_{t , Nr} ( n ) {\hat{x}}_{t} ( k \vert k - 1 )\end{matrix} ] .\end{matrix} \qquad ( 23 )$$

Since the channel matrix from the t^{th} transmit antenna and r^{th} receive antenna H_{t,r}(n) assumes the Toeplitz structure as

$${H}_{t , r} ( n ) = [ \begin{matrix}{h}_{t , 0}^{r} & … & {h}_{t , D}^{r} & & 0 \\ & ⋰ & & ⋰ & \\ 0 & & {h}_{t , 0}^{r} & … & {h}_{t , D}^{r}\end{matrix} ] , \qquad ( 24 )$$

the matrix-vector multiplication can be viewed as a FIR filter with the channel impulse response [h_{t,D}^{r}, . . . , h_{t,0}^{r}]. This can be implemented in the time domain by delayed tap line architecture as a conventional FIR. It is well known that the time-domain FIR filtering can also be implemented by FFT-based circular convolution in the frequency domain. In [ ], the “overlap-save” based matrix-vector multiplication architecture is proposed to accelerate the computation. The similar architecture can be applied directly to the Kalman filtering problem in this paper. This achieves O((F+D)log(F+D)) complexity algorithm versus O((F+D)²) for the matrix-vector multiplication and O((F+D)²log(F+D)) versus O((F+D)³) for the matrix-matrix multiplications in the innovation estimation and the Kalman Gain computer. The procedure is described briefly as following:
a) Take the FFT of the zero-padded channel impulse response [h_{t,D}^{r}, . . . , h_{t,0}^{r}, 0, . . . , 0].
b) Take the FFT of the right-product vector \hat{x}ₜ(k|k−1).
c) Compute the dot product of the frequency-domain coefficients.
d) Take the IFFT of the product.
e) Truncate the result to get the valid coefficients as the matrix-vector multiplication result.

The FFT-based architecture for the MIMO observation estimate ŷ(k)=H(k)\hat{x}(k|k−1) is depicted in FIG. 4. First, the element-wise FFT bank computes the frequency coefficients of each of the zero-padded MIMO channel impulse response. Simultaneously, another FFT bank computes the dimension-wise coefficients of the estimated state. The dot product of the two groups of coefficients are computed according to the transmit antenna index t. Then the results are grouped by the receive antenna index r by summing the result for all the transmit antennas. A dimension-wise FFT-bank with Nᵣ IFFTs computes the dot products correspondingly and truncates the result according to the “over-lap save” architecture to generate estimated observation. For a matrix-matrix multiplication involved with the block-Toeplitz channel matrix, we can extend the matrix-vector multiplication architecture to multiple vectors in a straightforward way. Note that we only need to take FFT once for each channel impulse response. For the multiple vectors to be filtered, we can form a pipelined FFT computation to use the hardware resource efficiently.

d. Computation Update Rate

We discuss the computation rate of the FFT coefficients here. It is clear that for all the H(k) pre-multiplications in each of the k^{th} iteration, we only need to compute the element-wise FFT of H(k) once. We only need to compute the FFTs of the right-hand multiply factor and the dot products individually. Specifically, if we define

$$\begin{matrix}{\hat{y}}_{r} ( k ) = {\sum }_{t = 1}^{M} {H}_{t , r} ( k ) {\hat{x}}_{t} ( k \vert k - 1 ) for r = 1 \text{:} {N}_{r} , t = 1 \text{:} M ; & ( 25 ) \\ {Ω}_{r , t} ( k ) = {\sum }_{{t}_{1} = 1}^{M} {H}_{{t}_{1} , r} ( k ) {P}_{{t}_{1} , t} ( k \vert k - 1 ) for r = 1 \text{:} {N}_{r} , t = 1 \text{:} M , & ( 26 )\end{matrix}$$

we only need to compute the element-wise FFT of H_{t,r}(k) once for both the multiplications. Moreover, even in a fast fading environment, it is most likely that we can assume the channel impulse response is constant for many symbols in a frame. Thus, for the coherence time that the channel coefficients are assumed to be quasi-static, i.e H(k)=H, we only need to compute the FFTs once. For each symbol, there will be one dimension-wise (in the domain of transmit antenna) FFT bank for the estimated state \hat{x}ₜ(k|k−1) and one dimension-wise (in the domain of receive antenna) IFFT bank for the observation estimate ŷᵣ(k). For the computation of the Ω(k) matrix, there will be element-wise FFT banks for the P(k|k−1). However, after we examine the structure of the P(k|k−1), it is clear that the first F column of each of the P_{t1,t}(k|k−1) is constant matrix if the Q_{w}(k) is assumed to be constant for the observation frame. Only the right-bottom (D×D) corner of P_{t1,t}(k|k−1) is variable for each k. This is very likely even in a fast-fading environment as this is an input for a frame. Thus, only D columns need to be recomputed for each k. If we further assume that
Pₜ_{₁}_{,t}(k|k−1)=Pₜ_{₁}_{,t}(k|k−1)δ(t₁−t),
i.e. only the diagonal block of P(k|k−1) will be effective, the computation is simplified as:
Ω_{r,t}(k)=H_{t,r}P_{t,t}(k|k−1). (27)

It is seen that this simplification does not degrade the performance significantly. As a summary, the computation procedure is described with the different computation rate in Table II:

TABLE II
Summary of the FFT-acceleration for the matrix-vector multiplication.

Update/frame:
(1). The FFT bank of the channel and process error
correlation coefficients:

$\begin{matrix}{Φ}_{t , r} = fft ( {\tilde{h}}_{t , r} ) {\tilde{h}}_{t , r} = [ {h}_{ t , r } 0 ] t = 1 : M ; r = 1 : {N}_{r} \\ \tilde{Λ} ( ω ) = fft ( {\tilde{Q}}_{w} ) {\tilde{Q}}_{w} = {[ {{\tilde{Q}}_{w} ( k )}^{T} {0}_{F \times D} ]}^{T}\end{matrix}$

(2). The WET-truncation of dot product in the frequency
domain coefficients:

${Ω}_{r , t}^{U} ( col ) = truncate 〈 iff \{ {Φ}_{t , r} ∘ \tilde{Λ} ( ω , col ) \} 〉 col = 0 : F - 1$

Update/iteration k:
(1). FFT bank of the state estimate and effective state error correlation:

$\begin{matrix}{\hat{X}}_{t} ( ω , k ) = fft [ {\hat{x}}_{t} ( k \vert k - 1 ) ] t = 1 : M \\ {Γ}_{t1 , t2} ( ω , k ) = fft \{ {[ {0}_{D \times F} {{ρ}_{t1 , t2} ( k - 1 )}^{T} ]}^{T} ] \}\end{matrix}$

(3). The WET-truncation of the dot product in the frequency domain:

$\begin{matrix}{\hat{y}}_{r} ( k ) = truncate 〈 ifft \{ {\sum }_{t = 1}^{M} {Φ}_{t , r} ∘ {\hat{X}}_{t} ( ω , k ) \} 〉 r = 1 : Nr \\ {Ω}_{r , t} ( k , col ) = \{ \begin{matrix}{Ω}_{r , t}^{U} ( col ) col = 0 : F - 1 \\ truncate 〈 ifft \{ {Φ}_{t , r} ∘ {Γ}_{t , t} ( ω , k , col - f ) \} 〉 col = F : F + D\end{matrix}\end{matrix}$

For the computation of the correlation matrix of innovation as
R(k)=H(k)Ω^{H}(k)+Qᵥ(k)
is also accelerated by the FFT-based computing architecture in the frequency domain after the change of order with the Hermitian feature of P(k|k−1) and Qᵥ(k). The procedure is similar to the Table II for the computation of Ω^{H}(k). Thus, the direct matrix computation involving the channel matrix H(k) is replaced by the FFT-based procedure. This reduces the complexity and facilitates the parallel processing in VLSI architectures.
e. Iterative Inverse Solver

With the aforementioned optimizations, the complexity has been reduced dramatically. However, there is one last hard work in computing the Kalman gain G(k)=Ω^{H}(k)R⁻¹(k).

It is known that a Gaussian elimination can be applied to solve the matrix inverse with complexity of the order of O[(NF)³], where N is the number of receive antennas and F is channel length. Moreover, Cholesky decomposition-can also be applied to increase the speed by reducing the hidden constant factor in the order of complexity. However, since these two solutions do not use the structure of the matrix, the complexity is at the same order as for solving the inverse of a general matrix.

We made the observation that first, R is an (NF×NF) Hermitian symmetric matrix. This can be easily verified as R^{H}(k)=Ω(k)^{H}(k)^{H}+Qᵥ^{H}(k)=H(k)P(k|k−1)H(k)^{H}+Qᵥ(k)=R(k) because P(k|k−1)=P^{H}(k|k−1) and Qᵥ(k)=Qᵥ^{H}(k) are also Hermitian symmetric. It is known that the iterative CG (conjugate-gradient) algorithm can solve the inverse of this type of matrix more efficiently. Second, the full matrix of the G (Kalman gain) is not necessary from the displacement structure of the state transition matrix. Only the lower D×NF (Gₜ^{L}) and the left upper D×D (G_{t,r}^{U}) corner are required. This feature can also be used to optimize the matrix inverse and the matrix multiplication involved in the Kalman Gain computation.

To avoid having to directly compute the inverse of R using the iterative CG algorithm, the Kalman gain computation and the state update is re-partitioned to generate the following new problem.
X(k)=G(k)α(k)=Ω^{H}(k)[R⁻¹(k)α(k)]=Ω^{H}(k)Φ(k)
Ψ(k)=G(k)Ω(k)=Ω^{H}(k)[R⁻¹(k)Ω(k)]=Ω^{H}(k)Π(k)
where Φ(k)=R⁻¹(k)α(k) and Π(k)=R⁻¹(k)Ω(k) respectively. With this changed order of computation, the iterative procedure of the CG-based algorithm is described next.
f Computation of Φ(k)=R⁻¹(k)α(k):

The computation of Φ(k) is a direct application of the iterative CG algorithm. The procedure is shown in Table III.

TABLE III
Summary of the CG procedure for the Φ(k) = R⁻¹(k)α(k)

(1). Initialization

| Φ₀ = 0; | |
|---|---|
| γ₀ = α(k); Δ₀ = α(k); | |
| δ₀ = γ₀^{H}γ₀; | δ₁ = δ₀; |

(2). For an iteration from j = 1:J until convergence:

| | |
|---|---|
| Γⱼ = RΔⱼ₋₁; | μ = δⱼ/Δⱼ₋₁^{H}Γⱼ; |

Φⱼ = Φⱼ₋₁ + μΔⱼ₋₁
γⱼ = γⱼ₋₁ − μΓⱼ
δⱼ₊₁ = γⱼ^{H}γⱼ
ν = δⱼ₊₁/δⱼ
Δⱼ = γⱼ + νΔⱼ₋₁

In Table III, the quatities μ, v, and δⱼ are scalars, and Γⱼ, Δⱼ₋₁ and Φⱼ are vectors. Also, RΔⱼ₋₁ is a matrix-vector multiplication. Finally, Δⱼ₋₁^{H}Γⱼ and γⱼ^{H}γⱼ are inner products of two vectors.

Thus, the calculation of the inverse of the R matrix is reduced to performing matrix-vector multiplication in the recursive structure. The Kalman gain is not computed explicitly. Note that the vector X(k)=Ω^{H}(k)Φ(k) can also be partitioned into the X(k)=[ . . . Xₜ(k)^{T} . . . ]^{T}, Using the displacement structure for the filtered state estimate discussed in section III, the element vector Xₜ(k) can still be partitioned into the upper, center and lower portion as Xₜ^{U}(k)=[Xₜ^{U}(k) Xₜ^{C}(k)Xₜ^{L}(k)], where
Xₜ^{U}(k)=Ω^{U}(k)^{H}Φ(k)
Xₜ^{C}(k)=Ω^{C}(k)^{H}Φ(k), and
Xₜ^{L}(k)=Ω^{L}(k)^{H}Φ(k).
Using the displacement feedback we can feed back the upper portion once the result is ready, and so speed up the iteration pipelining, and so the complexity of this portion is reduced dramatically.
g. Update of Predicted State Error Correlation

Another computation involving the Kalman gain and the inverse of the correlation matrix of the innovation is the update of the predicted state error correlation P(k|k). With the definition of Π(k)=R⁻¹(k)Ω(k), the CG procedure will need to be applied to the column vectors of Π(k) and Ω(k). Similar to eqn. (21), it can be shown that Ψ(k)=Ω^{H}(k)Π(k) can also be partitioned into sub-block matrices for the MIMO configuration. The element is given by

$${Ψ}_{t 1 , t 2} ( k ) = {\sum }_{r = 1}^{Nr} {[ {Ω}_{r , t 1} ( k ) ]}^{H} {Π}_{r , t 2} ( k )$$

where the Ω_{r,t1}(k) is the element of the omega matrix Ω(k) and Π(k) is partitioned to

$${Π}_{r , t 2} ( k ) = [ \begin{matrix}{Π}_{1 , 1} ( k ) & … & {Π}_{1 , M} ( k ) \\ ⋮ & {Π}_{r , t} ( k ) & \\ {Π}_{Nr , 1} ( k ) & & {Π}_{Nr , M} ( k )\end{matrix} ] .$$

Since only the left upper corner in Ψ_{t1,t2}(k) is of interest as shown in

$${Ψ}_{t 1 , t 2} ( k ) = [ \begin{matrix}{\sum }_{r = 1}^{Nr} {[ {Ω}_{r , t 1}^{L} ( k ) ]}^{H} {Π}_{r , t 2}^{L} ( k ) & … \\ … & …\end{matrix} ] .$$

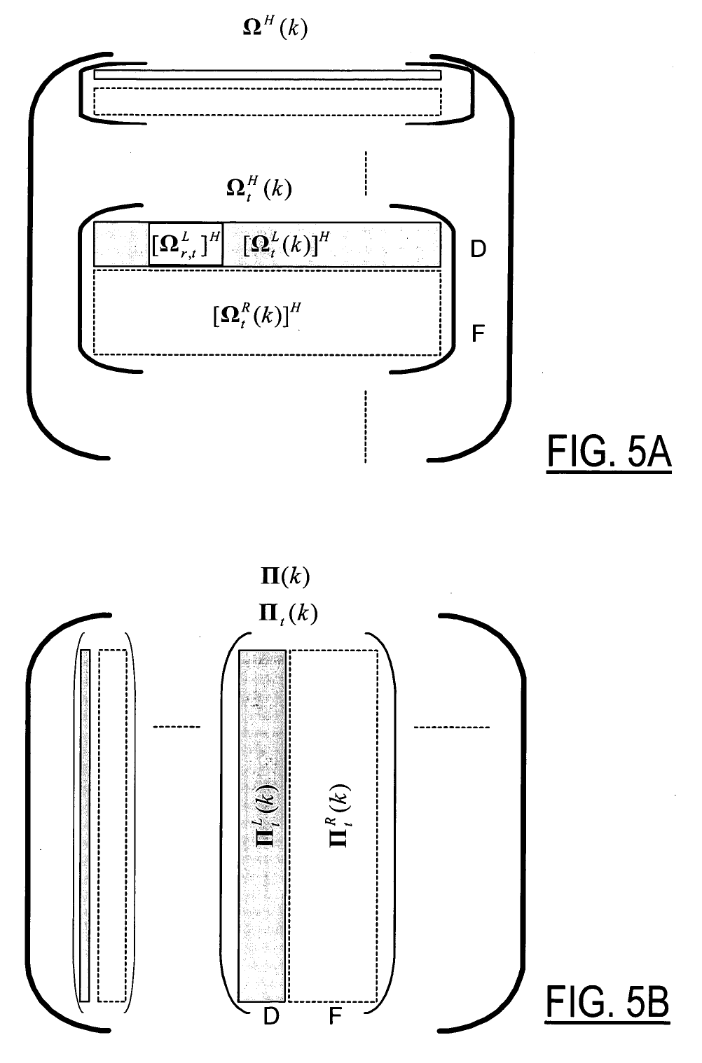

The full matrix of Π(k) is not necessary and the whole matrix multiplication by Ω^{H}(k) is redundant. Thus, if the Π(k) is defined by column sub-matrices as Π(k)=[Π₁(k) . . . Πₜ(k) . . . Π_{M}(k)], and each Πₜ(k) is further partitioned into the left portion and right portion as Πₜ(k)=[Πₜ^{L}(k)Πₜ^{R}(k)], we only need to calculate the left portion from the CG iterative algorithm. Because the iterative algorithm finally reduces to matrix-vector multiplications in a loop, the interested columns can be easily identified and picked up by simply ignoring the right portions. The effective data for both the Ω^{H}(k) and Π(k) are shown in FIGS. 5A and 5B respectively, as the shaded portion. The iterative procedure to compute the matrix inverse and multiplication Π(k)=R⁻¹(k)Ω(k) is only necessary for the effective data as follows.

TABLE IV
Summary of the CG procedure for partial Π(k) = R⁻¹(k)Ω(k)

(1). Initialization for t = 1:M

Π_{t, 0} = 0;
η_{t, 0} = Ωₜ^{L}(k); λ_{t, 0} = Ωₜ^{L}(k);
κ_{t, 0, l} = [η_{t, 0}(:, l)]^{H} η_{t, 0}(:, l); κ_{t, 1, l} = κ_{t, 1, l}; for l = 1:D

(2). for t = 1:M, form an iteration from j = 1:J until convergence:

| | |
|---|---|
| | ξ_{t, j} = Rλ_{t, j-1}; |
| for l = 1:D: | ρ_{t, l} = κ_{t, j, l}/{[λ_{t, j-1}(:, l)]^{H} *ξ_{t, j}(:, l)}; |
| | Π_{t, j} = Π_{t, j-1} + λ_{t, j-1}*diag(ρ_{t, 1}, . . . , ρ_{t, l}, . . . , ρ_{t, D}); |
| | η_{t, j} = η_{t, j-1} − ξ_{t, j} *diag(ρ_{t, 1}, . . . , ρ_{t, l}, . . . , ρ_{t, D}); |
| for l = 1:D: | κ_{t, j+1, l} = η_{t, j}^{H}(:, l)*η_{t, j}(:, l); σ_{t, l} = κ_{t, j+1, l}/κ_{t, j, l} |
| | λ_{t, j} = η_{t, j} + λ_{t, j-1}*diag(σ_{t, 1} . . . σ_{t, l} . . . σ_{t, D}) |

In Table IV, the notation A_{i,j}(:,l) denotes the l^{th} column vector of the matrix Aᵢⱼ, which in turn is a subblock matrix of a the (full) matrix A. The full matrix A is partitioned into subblock matrices A_{i,j} so as to be expressible as:

$$A = [ \begin{matrix}{A}_{11} & ⋯ & \\ & {A}_{i , j} & ⋮ \\ ⋯ & & \end{matrix} ] .$$

The notation A_{i,j}(:,l) indicates a vector having as components the l^{th} column of the subblock matrix A_{i,j}=[A_{i,j}(:,l) . . . A_{i,j}(:,l) . . . ], i.e.

$${A}_{i , j} ( \text{:} , l ) = [ \begin{matrix}{A}_{i , j} ( 1 , l ) \\ ⋮ \\ {A}_{i , j} ( k , l ) \\ ⋮\end{matrix} ] .$$

Also, ρ_{t,l}, σ_{t,l}, κ_{i,j+1,l} are scalars η_{t,j}^{H}(:,l), λ_{i,j-1}(:,l) and ξ_{i,j}(:,l) are the l-th column vectors of the submatrices ηₜⱼ, λᵢⱼ₋₁, and ξₜⱼ, respectively, where t is the transmit antenna index and j is the iteration number. So the related computations in the above procedure include a matrix-vector multiplication as in Rλᵢⱼ₊₁, the inner product (also called the scalar product because it results in a scalar) of two vectors as in [λₜⱼ₋₁(:,l)]^{H}·ξₜⱼ(:,l) and as in ηₜⱼ^{H}(:,l)·ηₜⱼ(:,l) and some scalar multiplications as in ρ_{t,l}λₜⱼ₋₁(:,l) and μ_{t,l}ξₜⱼ(:,l) and σ_{t,l}λₜⱼ₋₁(:,l) for l=1:D. The scalar product (i.e. the inner product, as opposed to the multiplication of two scalars) is denoted in a compact form as λₜⱼ₋₁·diag(ρ_{t,l}, . . . , ρ_{t,l}, . . . , ρ_{t,D}) and ξₜⱼ·diag(ρ_{t,l}, . . . , ρ_{t,l}, . . . , ρ_{t,D}) and λₜⱼ₋₁·diag(σ_{t,l} . . . σ_{t,l} . . . σ_{t,D}) respectively, where diag(ρ_{t,l}, . . . , ρ_{t,l}, . . . , ρ_{t,D}) as in:

$$diag ( {ρ}_{t , 1} , ⋯ , {ρ}_{t , 1} , ⋯ , {ρ}_{t , D} ) = [ \begin{matrix}{ρ}_{t , 1} & 0 & ⋯ & 0 \\ 0 & ⋰ & & \\ ⋮ & & & 0 \\ 0 & ⋯ & 0 & {ρ}_{t , D}\end{matrix} ] .$$

(Thus, λₜⱼ₋₁·diag(ρ_{t,l}, . . . , ρ_{t,l}, . . . , ρ_{t,D}) is compact notation for l=1:D of the ρ_{t,l}*λₜⱼ₋₁(:,l), and so there is actually no matrix computation. Instead, we only carry out a scaling of each column vector using the corresponding scalor p_{t,l}.)

Note that the D columns in the t^{th} sub-column matrix can be computed independently, as well as the M sub-columns. The computation of κ_{t,0}^{H}=η_{t,0}(:,l) is actually a norm computation for the l^{th} column vector of η_{t,0}, i.e. η_{t,0}(:,l). Similarly, ξₜⱼ(:,l) is the l^{th} column vector of ξₜⱼ and λₜⱼ₋₁(:,l) the l^{th} column vector of λₜⱼ₋₁. The computation of κ_{ij+t,l}, and ρ_{t,l} only involves the so-called dot-product (scalar product) of two vectors. The matrix multiplications λₜⱼ₋₁diag(ρ_{t,l} . . . ρ_{t,l} . . . ρ_{t,D}), ξₜⱼdiag(ρ_{t,l} . . . ρ_{t,l} . . . ρ_{t,D}), and λₜⱼ₋₁diag(σ_{t,l} . . . σ_{t,l} . . . σ_{t,D}) are actually implemented by independent scaling of the column vectors of the left-side matrix. The computation is dominated by the matrix-submatrix multiplication ξₜⱼ=Rλₜⱼ₋₁ which requires D independent matrix-vector multiplications. Thus, the direct-matrix inverse of R is avoided and the “inverse+multiplication” is reduced to a small portion of the matrix-vector multiplications in an iteration loop. Combining the complexity reduction in calculating Ψ_{t1,t2}(k), the complexity order is reduced significantly.

Note that the CG algorithm alone converts the matrix inverse of R and the matrix multiplication of R⁻¹(k)Ω(k) into an iterative matrix-matrix multiplication RΩ. If the whole matrix-matrix multiplication needs to be computed, the complexity is still O(N³). However, with the displacement structure, we also need to compute a portion of the matrix-matrix multiplication of RΩ, which is determined by the effective data of Ω as shown in FIG. 5A.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus, comprising:
a radio section, responsive to a plurality of signals wirelessly received over a communication channel using a plurality of receive antennas, for providing a received signal; and
a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

2. An apparatus as in claim 1, wherein the Kalman filter includes a transition and common data path, and the transition and common data path is responsive to the set of values indicating predicted state error correlation at a first instant of time given all noise estimates up through the first instant, and provide the set of values indicating a product of measurement values and predicted state error correlation at a later instant of time given all process noise estimates up through the later instant.

3. An apparatus as in claim 2, wherein the Kalman filter includes a gain calculator for providing a Kalman gain, the gain calculator comprising the transition and common data path and further comprising a Riccati processor and a Kalman gain processor, wherein the set of values indicating a product of measurement values and predicted state error correlation at a later instant of time given all process noise estimates up through the later instant is provided by the transition and common data path to both the Riccati processor and the Kalman gain processor.

4. An apparatus as in claim 3, wherein the Kalman filter also includes a state estimator, responsive to the received signal and to the Kalman gain, for providing a filtered state estimate as the processed signal indicating information conveyed by the received signal.

5. An apparatus as in claim 3, wherein the transition and common data path also provides to the Riccati processor a set of values indicating predicted state error correlation at the later instant of time given a set of values indicating predicted state error correlation at the first instant.

6. An apparatus as in claim 5, wherein the Riccati processor provides a set of values indicating state error correlation at the later instant given all noise estimates up through the later instant, based on a set of values of gain at the later instant provided by the gain processor and also based on the sets of values provided by the transition and common data path.

7. An apparatus as in claim 3, wherein the Kalman gain processor is responsive to a set of values indicating measurement noise at the later instant and to the set of values provided by the transition and common data path, and provides a set of values indicating gain at the later instant.

8. An apparatus as in claim 1, wherein transitions from one state to a next state and corresponding error correlations are determined based on a state transition matrix partitioned into blocks corresponding to a displacement structure, and a shifting operation is performed instead of a multiplication in determining values corresponding to mathematical expressions including a term in which the state transition matrix multiplies a matrix or a vector.

9. An apparatus as in claim 8, wherein the transitions from one state to a next are performed based on a state transition equation including the state transition matrix and based on partitioning the state transition equation into blocks with one block for each transmit antenna, and a next state is determined using the shifting operation for each block.

10. An apparatus as in claim 8, wherein filtered state estimates are determined based on a state estimate equation with terms depending on the state transition matrix and based on partitioning the state estimate equation into blocks with one block for each transmit antenna so as to provide a state estimate equation for each transmit antenna, and a filtered state estimate is determined using the shifting operation for each block.

11. An apparatus as in claim 8, wherein a filter gain is determined based on innovation equations with terms depending on the state transition matrix and also depending on a measurement matrix representing the communication channel and based on partitioning the measurement matrix into blocks with each block corresponding to a pair of one receive antenna and one transmit antenna.

12. An apparatus as in claim 11, wherein vector multiplication by the measurement matrix is implemented so as to correspond to a delayed tap line.

13. An apparatus as in claim 8, wherein a conjugate-gradient algorithm and the displacement structure are used to reduce a matrix inverse operation to one or more matrix-vector or matrix-matrix multiplications.

14. A wireless terminal, including a receiver section having an apparatus, the apparatus comprising:
a radio section, responsive to a plurality of signals wirelessly received over a communication channel using a plurality of receive antennas, for providing a received signal; and
a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

15. A wireless terminal as in claim 14, wherein the wireless terminal is either a user equipment device or an entity of a radio access network of a cellular communication system wirelessly coupled to the user equipment device.

16. A system, comprising a user equipment device and an entity of a radio access network of a cellular communication system wirelessly coupled to the user equipment device, wherein at least either the user equipment device or the entity of the radio access network include an apparatus, comprising:
a radio section, responsive to a plurality of signals wirelessly received over a communication channel using a plurality of receive antennas, for providing a received signal; and
a Kalman filter, responsive to the received signal, for providing a corresponding processed signal indicating information conveyed by the received signal, responsive to a set of values indicating predicted state error correlation at a first instant of time given all noise estimates up through the first instant, for providing a set of values indicating a product of measurement values and predicted state error correlation at a later instant of time given all process noise estimates up through the later instant.

17. A method, comprising:
wirelessly receiving a plurality of signals over a communication channel using a plurality of receive antennas, for providing a received signal; and
Kalman filtering the received signal so as to provide a corresponding processed signal indicating information conveyed by the received signal, based on processing a set of values indicating predicted state error correlation at a first instant of time given all noise estimates up through the first instant so as to provide a set of values indicating a product of measurement values and predicted state error correlation at a later instant of time given all process noise estimates up through the later instant.

18. A method as in claim 17, wherein the Kalman filtering includes using a transition and common data path to provide the set of values indicating a product of measurement values and predicted state error correlation at a later instant of time given all process noise estimates up through the later instant.

19. A method as in claim 18, wherein the Kalman filtering includes a gain calculator step for providing a Kalman gain, wherein the gain calculator step uses the transition and common data path to provide to both a Riccati processor step and a Kalman gain processor step the predicted state error correlation at a later instant of time given all process noise estimates up through the later instant.

20. A method as in claim 19, wherein the Kalman filtering also includes a state estimator step, responsive to the received signal and to the Kalman gain, for providing a filtered state estimate as the processed signal indicating information conveyed by the received signal.

21. A computer program product comprising a computer readable storage structure embodying computer program code thereon for execution by a computer processor, wherein said computer program code comprises instructions for performing a method comprising:
wirelessly receiving a plurality of signals over a communication channel using a plurality of receive antennas, for providing a received signal; and
Kalman filtering the received signal so as to provide a corresponding processed signal indicating information conveyed by the received signal, based on processing a set of values indicating predicted state error correlation at a first instant of time given all noise estimates up through the first instant so as to provide a set of values indicating a product of measurement values and predicted state error correlation at a later instant of time given all process noise estimates up through the later instant.
